(19) United States
(12) Patent Application Publication
(10) Pub. No.: US 2021/0058839 A1
(43) Pub. Date: Feb. 25, 2021

(54) MEASUREMENT CONTROL METHOD, UE, NETWORK APPARATUS, AND COMPUTER STORAGE MEDIUM

(71) Applicant: GUANGDONG OPPO MOBILE TELECOMMUNICATIONS CORP., LTD., Dongguan (CN)

(72) Inventor: Ning YANG, Dongguan (CN)

(21) Appl. No.: 17/092,090

(22) Filed: Nov. 6, 2020

Related U.S. Application Data
(63) Continuation of application No. PCT/CN2018/086048, filed on May 8, 2018.

(51) Int. Cl. H04W 36/08; H04W 36/00; H04W 76/11; H04W 76/27

(52) U.S. Cl. CPC H04W 36/08; H04W 36/0058; H04W 76/27; H04W 76/11; H04W 36/0077

(57) ABSTRACT

The present disclosure discloses a measurement control method, user equipment (UE), a network apparatus, and a computer storage medium. The method comprises: if the UE is within a first region while performing cell re-selection, determining, on the basis of a cell global identity list configured at a network side, or on the basis of a PCI list and the cell global identity list configured at the network side, whether a cell to be re-selected belongs to the first region; and if so, continuing to use an idle state measurement configuration configured by dedicated signaling to perform processing.

### CROSS-REFERENCE TO RELATED APPLICATIONS

The present application is a continuation of International Application No. PCT/CN2018/086048, filed on May 8, 2018, the contents of which are hereby incorporated by reference in its entirety.

### TECHNICAL FIELD

The present disclosure relates to the field of information processing technology, and in particular, to a measurement control method, user equipment (UE), network apparatus, and computer storage medium that determine whether a terminal performs measurement on a preset cell in an idle state by determining whether a cell belongs to a pre-configured area.

### BACKGROUND

In the 3GPP LTE system, a carrier aggregation mechanism is introduced and continuously developed. One of the enhancement directions is to speed up a configuration of a secondary cell by a network to a terminal to avoid a situation where the configuration of the secondary cell is too slow and more data needs to be transmitted through a primary cell. In the LTE system, a dedicated frequency priority may be configured when RRC connection is released, and may be implemented according to the RAT and Frequency Selection Policy (RFSP) configured by the network. In the carrier aggregation, in order to achieve a rapid configuration of the secondary cell, a dedicated signaling configuration for idle state measurement is also introduced for an idle terminal, and a timer is also set.

### SUMMARY

Embodiments of the present disclosure provide a measurement control method, user equipment (UE), network apparatus, and computer storage media.

An embodiment of the present disclosure provides a measurement control method, which is applied to a UE. The method includes:

if the UE is within a first area while performing cell re-selection, determining, on the basis of a cell global identifier list configured at a network side, or on the basis of a PCI list and the cell global identifier list configured at the network side, whether a cell to be re-selected belongs to the first area;

if it is determined that the cell to be re-selected belongs to the first area, continuing to use an idle state measurement configuration configured by dedicated signaling to perform processing.

An embodiment of the present disclosure provides a measurement control method, which is applied to a network apparatus. The method includes:

configuring a UE with a cell global identifier list, or with a PCI list and the cell global identifier list.

An embodiment of the present disclosure provides a UE. The UE includes:

a first processing unit, configured to: if within a first area while performing cell re-selection, determine, on the basis of a cell global identifier list configured at a network side, or on the basis of a PCI list and the cell global identifier list configured at the network side, whether a cell to be re-selected belongs to the first area; if it is determined that the cell to be re-selected belongs to the first area, continue to use an idle state measurement configuration configured by dedicated signaling to perform processing.

An embodiment of the present disclosure provides a network apparatus, including:

a second communication unit, configured to: configure a UE with a cell global identifier list, or with a PCI list and the cell global identifier list.

A UE provided by an embodiment of the present disclosure includes a processor and a memory for storing a computer program executable on the processor,

wherein, in a case where the processor is used to execute the computer program, steps of the foregoing method are performed.

A network apparatus provided by an embodiment of the present disclosure includes: a processor and a memory for storing a computer program executable on the processor,

wherein, in a case where the processor is used to execute the computer program, steps of the foregoing method are performed.

An embodiment of the present disclosure provides a computer storage medium that stores computer-executable instructions, and in a case where the computer-executable instructions are executed, steps of the foregoing method are implemented.

In addition, the implementation of the present disclosure is also applicable to a 5G NR system. Both LTE and NR use the PCI as a physical layer cell identifier, and the cell global identifiers are respectively an E-UTRA Cell Global Identifier (E-CGI) and an NR Cell Global Identifier (N-CGI).

### BRIEF DESCRIPTION OF THE DRAWINGS

FIG. 1 is a schematic flowchart of a measurement control method according to an embodiment of the present disclosure;

FIG. 2 is a schematic diagram of a scenario where PCI confusion occurs;

FIG. 3 is a schematic structural diagram of a UE according to an embodiment of the present disclosure;

FIG. 4 is a schematic structural diagram of a network apparatus according to an embodiment of the present disclosure; and

FIG. 5 is a schematic diagram of a hardware architecture according to an embodiment of the present disclosure.

### DETAILED DESCRIPTION

In order to understand the features and technical contents of the embodiments of the present disclosure in more detail, the following describes the implementation of the embodiments of the present disclosure in detail with reference to the drawings. The accompanying drawings are for reference only and are not intended to limit the embodiments of the present disclosure.

### Embodiment 1

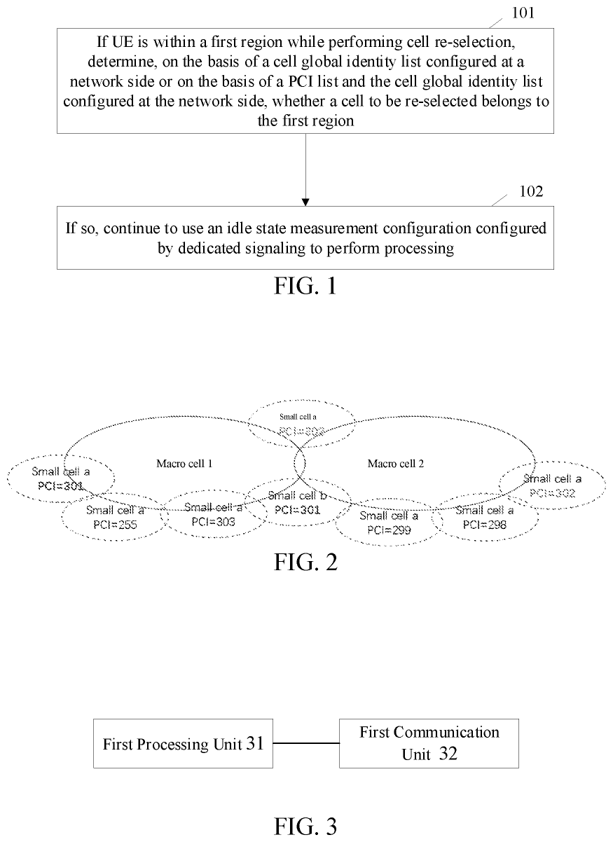

An embodiment of the present disclosure provides a measurement control method, which is applied to a UE. As shown in FIG. 1, the method includes:

Step 101, if the UE is within a first area while performing cell re-selection, determine, on the basis of a cell global identifier list configured at a network side or on the basis of a Physical Cell Identifier (PCI) list and the cell global identifier list configured at the network side, whether a cell to be re-selected belongs to the first area;

Step 102, if so, continue to use an idle state measurement configuration configured by dedicated signaling to perform processing.

It should be noted that the embodiments of the present disclosure may be applied to various communication systems, such as: a Global System of Mobile Communication (GSM) system, a Code Division Multiple Access (CDMA) system, a Wideband Code Division Multiple Access (WCDMA) system, a General Packet Radio Service (GPRS), a Universal Mobile Telecommunication System (UMTS), an LTE system and LTE system evolution system (e.g., an Advanced Long Term Evolution (LTE-A) system), an NR system and NR system evolution system (e.g., an NR-based access to Unlicensed spectrum (NR-U)), or a next-generation communication system, etc.

A User Equipment (UE) may be a STAION (ST) in a Wireless Local Area Network (WLAN), and may be a cellular phone, a cordless phone, a Session Initiation Protocol (SIP) phone, a Wireless Local Loop (WLL) station, a Personal Digital Assistant (PDA) device, a handheld device with a wireless communication function, a computing device or other processing devices connected to a wireless modem, an vehicle-mounted device, a wearable device and a next-generation communication system, such as: a terminal device in a fifth-generation (5G) network or a terminal device in a Public Land Mobile Network (PLMN) that will evolve in the future, etc.

The above network side may be understood as a network apparatus in the network, which may be an apparatus for communicating with a mobile device, and the network apparatus may be an Access Point (AP) in a WLAN, a Base Transceiver Station (BTS) in GSM or CDMA, and may also be a NodeB (NB) in WCDMA, or an Evolutional Node B (eNB or eNodeB) in LTE, or a relay station or access point, or a vehicle-mounted device, a wearable device and a network apparatus in the NR network or a network apparatus in the PLMN that will evolve in the future.

In the embodiment of the present disclosure, the network apparatus may provide services for the cell, and the UE communicates with the network apparatus through transmission resources (e.g., frequency domain resources, or spectrum resources) used by the cell, and the cell may be a cell corresponding to a network apparatus (e.g., a base station), the cell may belong to a macro base station, or may belong to a base station corresponding to a small cell. The small cell may include: a Metro cell, a Micro cell, a Pico cell, a Femto cell, etc.

It should be noted that the network side may only send the PCI list to the UE side, but this process will not be described in detail in this embodiment.

Before the aforementioned Step 101, the method further needs to include: obtaining the cell global identifier list configured by the network side through RRC signaling, or the configured PCI list and the cell global identifier list.

Specifically, the base station may send the PCI list+the cell global identifier list to the UE; further, the implementations provided by the embodiments of the present disclosure are also applicable to 5G NR systems. Both LTE and NR use the PCI as a physical layer cell identifier, and the cell global identifier may be an E-UTRA Cell Global Identifier (E-CGI) and an NR Cell Global Identifier (N-CGI), respectively. In the LTE system or 5G NR system, the E-CGI or N-CGI sent by the base station may be optional.

At the UE side, if the network side configures the cell global identifier list for the UE side, when the UE is within a first area while performing cell re-selection, determining whether a cell to be re-selected belongs to the first area on the basis of a cell global identifier list configured at a network side, or on the basis of a PCI list and the cell global identifier list configured at the network side, may include the process that follows.

Type 1:

If the UE is within the first area and a timer has not expired, determine whether a PCI of the cell is in the PCI list configured at the network side while performing the cell re-selection; if the PCI of the cell is not in the PCI list, determine that the cell does not belong to the first area.

That is, if the UE has not left the first area and the timer has not expired, then, when the UE determines whether a cell belongs to a configured active area during a re-selection process, if a value of the PCI is different from any value in the configured PCI list, determine that the cell must not belong to the first area.

Type 2: If the UE is within the first area and the timer has not expired, determine whether a PCI of the cell is in the PCI list configured at the network side, and determine whether a cell global identifier of the cell is the same as the cell global identifier configured at the network side while performing the cell re-selection;

if the PCI of the cell is in the PCI list configured at the network side, and the cell global identifier of the cell is the same as the cell global identifier configured at the network side, determine that the cell belongs to the first area.

It should be further explained that the method for the UE to obtain the global identifier of the cell may be reading from a system message sent by the network side. More specifically, the cell global identifier may be read from SIB 1 in the system message sent by the network side; for example, E-CGI and N-CGI.

That is, if the UE has not left the first area and the timer has not expired, during the cell re-selection process, if the value of the PCI is the same as a PCI value in the configured PCI list, the UE needs to read SIB1 and obtain E-CGI to further compare whether the cell belongs to this first area;

if there is a same identifier in the E-CGI of the cell read by the UE and the E-CGI list configured at the network side, it is determined that the cell belongs to the first area.

Type 3: When performing the cell re-selection, if a reselected cell is not within the first area and/or the timer expires, determine that the UE leaves the first area.

That is, if the UE finds that a cell that does not belong to the first area is reselected or the timer expires, it considers that the UE has left the first area.

Further, if the base station is only configured with an E-CGI list (e.g., with an inactive state), the terminal needs to always read the E-CGI.

It should be understood that in an implementation provided in this embodiment, the first area may be an active area, but it is not only suitable for an active area of carrier aggregation idle state measurement, but also suitable for other areas, such as an inactive area like a RAN Area, a Tracking Area (TA), a Registration Area (RA), etc., which is no longer exhaustive here.

Regarding a process of adding a CGI, that is, the cell global identifier, to a cell list (Cell list r-15), the following methods may be adopted:

| IdleModeMeasurementConfigDedicated-r15 ::= SEQUENCE { | |
|---|---|
| idleMeasuredCarriersEUTRA-r15 | EUTRA-CarrierList-r15 |

OPTIONAL, -- Need OR

| | |
|---|---|
| idleMeasurementDuration-r15 | ENUMERATED {sec10, sec30, sec60, |

sec120, sec180, sec240, sec300},

| | | |
|---|---|---|
| validity Area-r15 | CellList-r15 | OPTIONAL - |

- Need OR

| ... | |
|---|---|
| } | |
| CellList-r15 ::= | SEQUENCE (SIZE (1.. maxCellMeasIdle-r15)) OF |

validCellList

| validCellList:= SEQUENCE { | | |
|---|---|---|
| physicalCellID | , | |
| cellGlobalId | CellGlobalIdEUTRA, | OPTIONAL |

}

On the basis of the foregoing description, this embodiment may further include:

sending information of a cell where PCI confusion occurs to the network side; wherein, the information of the cell where the PCI confusion occurs includes at least: a PCI and a cell global identifier of the cell; receiving reconfiguration information for the cell where the PCI confusion occurs sent by the network side; wherein, the reconfiguration information includes a reconfigured PCI of the cell where the PCI confusion occurs.

For a scenario where the PCI confusion occurs, please refer to FIG. 2, for example, an area of Macro cell 1 contains two Small cells with PCI=301; in an area of Macro cell 2, there are two Small cells with PCI=302. It may be considered that the above two Small cells with PCI=301 and 302 will have the PCI confusion.

If the terminal finds that misjudging of the active area may be caused by PCI detection alone due to the PCI confusion, the terminal reports the information of the cell where the PCI confusion occurs to the network side, and triggers the network side to reconfigure a PCI of the cell. When reporting, the terminal reports the PCI+E-CGI of the cell to the network together to assist the network in locating which cell has the PCI confusion.

In addition, the foregoing Step 102 may further include: if determining that the UE has left the first area, not using the idle state measurement configuration configured by the dedicated signaling of the first area.

It should be understood that, in this embodiment, the E-CGI is mainly used for illustration, but when this embodiment is applied to a 5G NR system, the E-CGI may be replaced with the N-CGI, and the processing method is the same as that of this embodiment, which will not be repeated here.

It may be seen that by the above implementations, the UE, determines, on the basis of the cell global identifier list configured at the network side, or on the basis of the configured PCI list and cell global identifier list, whether the cell belongs to the configured area; furthermore, according to the determined result, determines whether to continue to use the idle signal measurement configuration configured by the dedicated signaling. In this way, it solves a problem that the UE misjudges a cell with a same PCI but does not belong to a first area where it is located, so that the UE may more accurately determine whether a reselected cell belongs to a specific area, thereby avoiding unnecessary measurement behavior of the UE caused by the misjudging.

### Embodiment 2

An embodiment of the present disclosure provides a measurement control method, which is applied to a network apparatus, and the method includes:

configuring a UE with a cell global identifier list, or with a PCI list and the cell global identifier list.

Specifically, the UE may be configured with the cell global identifier list, or with the PCI list and the cell global identifier list through RRC signaling.

It should be noted that the embodiments of the present disclosure may be applied to various communication systems, such as: a Global System of Mobile Communication (GSM) system, a Code Division Multiple Access (CDMA) system, a Wideband Code Division Multiple Access (WCDMA) system, General Packet Radio Service (GPRS), a Universal Mobile Telecommunication System (UMTS), an LTE system and LTE system evolution system (e.g., an Advanced long term evolution (LTE-A) system), an NR system and NR system evolution system (e.g., an NR-based access to Unlicensed spectrum (NR-U) system), or a next-generation communication system, etc.

A User Equipment (UE) may be a STAION (ST) in a Wireless Local Area Network (WLAN), and may be a cellular phone, a cordless phone, a Session Initiation Protocol (SIP) phone, a Wireless Local Loop (WLL) station, a Personal Digital Assistant (PDA) device, a handheld device with a wireless communication function, a computing device or other processing device connected to a wireless modem, an vehicle-mounted device, a wearable device and the next-generation communication system, such as, a terminal device in a fifth-generation (5G) network or a terminal device in a Public Land Mobile Network (PLMN) that will evolve in the future.

The above network side may be understood as a network apparatus in the network, which may be an apparatus for communicating with a mobile device, and the network apparatus may be an Access Point (AP) in a WLAN, a Base Transceiver Station (BTS) in GSM or CDMA, and may also be a NodeB (NB) in WCDMA, or an Evolutional Node B (eNB or eNodeB) in LTE, or a relay station or access point, or a vehicle-mounted device, a wearable device and a network apparatus in the NR network or a network apparatus in the PLMN that will evolve in the future.

In the embodiment of the present disclosure, the network apparatus may provide services for the cell, and the UE communicates with the network apparatus through transmission resources (e.g., frequency domain resources, or spectrum resources) used by the cell, and the cell may be a cell corresponding to a network apparatus (e.g., a base station), the cell may belong to a macro base station, or may belong to a base station corresponding to a small cell. The small cell may include: a Metro cell, a Micro cell, a Pico cell, a Femto cell, etc.

It should be noted that the network side may only send a PCI list to a UE side, but this process will not be described in detail in this embodiment.

Specifically, the base station may send the PCI list+the cell global identifier list to the UE; further, the implementations provided by the embodiments of the present disclosure are also applicable to 5G NR systems. Both LTE and NR use the PCI as a physical layer cell identifier, and the cell global identifier may be an E-UTRA Cell Global Identifier (E-CGI) and an NR Cell Global Identifier (N-CGI), respectively. In the LTE system or 5G NR system, the E-CGI or N-CGI sent by the base station may be optional.

It should be understood that in an implementation provided in this embodiment, the first area may be an active area, but it is not only suitable for an active area of carrier aggregation idle state measurement, but also suitable for other areas, such as a RAN Area with an inactive state, a Tracking Area (TA), a Registration Area (RA), etc., which is no longer exhaustive here.

Regarding a process of adding a CGI, that is, the cell global identifier, to a cell list (Cell list r-15), the following methods may be adopted:

| IdleModeMeasurementConfigDedicated-r15 ::= SEQUENCE { | |
|---|---|
| idleMeasuredCarriersEUTRA-r15 | EUTRA-CarrierList-r15 |

OPTIONAL, -- Need OR

| | |
|---|---|
| idleMeasurementDuration-r15 | ENUMERATED {sec10, sec30, sec60, |

sec120, sec180, sec240, sec300},

| | | |
|---|---|---|
| validity Area-r15 | CellList-r15 | OPTIONAL - |

- Need OR

| ... | |
|---|---|
| } | |
| CellList-r15 ::= | SEQUENCE (SIZE (1.. maxCellMeasIdle-r15)) OF |

validCellList

| validCellList:= SEQUENCE { | | |
|---|---|---|
| physicalCellID | PhysicalCellID, | |
| cellGlobalId | CellGlobalIdEUTRA, | OPTIONAL |

}

On the basis of the foregoing description, this embodiment may further include:

the network apparatus receives, from the UE, information of a cell where PCI confusion occurs, wherein, the information of the cell where the PCI confusion occurs includes at least: a PCI and a cell global identifier of the cell;

sending reconfiguration information for the cell where the PCI confusion occurs to the UE; wherein, the reconfiguration information includes at least: a PCI and a cell global identifier of a reconfigured PCI of the cell where the PCI confusion occurs.

For a scenario where the PCI confusion occurs, please refer to FIG. 2, for example, an area of Macro cell 1 contains two Small cells with PCI=301; in an area of Macro cell 2, there are two Small cells with PCI=302. It may be considered that the above two Small cells with PCI=301 and 302 will have the PCI confusion.

If the terminal finds that misjudging of the active area may be caused by PCI detection alone due to the PCI confusion, the terminal reports the information of the cell where the PCI confusion occurs to the network side, and triggers the network side to reconfigure a PCI of the cell. When reporting, the terminal reports the PCI+E-CGI of the cell to the network together to assist the network in locating which cell has the PCI confusion.

At the network apparatus, the following processing may further be included:

if the PCI confusion is occurred in the first area where the UE is located, configuring the UE with the cell global identifier list, or with the PCI list and the cell global identifier list;

or,

if no PCI confusion is occurred in the first area where the UE is located, only configuring the UE with the PCI list.

A basis for the network to determine whether an E-CGI is configured in the active area may be whether there is the PCI confusion in an area configured for the UE, if yes, the E-CGI is configured, and if not, no configuration is required. Compared with simply configuring the E-CGI, using PCI+E-CGI, may firstly determine if it has left the current area by whether the PCI is same, while it is unnecessary to read system information. Of course, this benefit may only be more obvious when the area is not large. In addition, the method of determining whether the UE has the PCI confusion within the first area may report the PCI confusion for the UE, for example, reporting PCI confusion information sent in a cell within the first area, and so on.

It should be understood that, in this embodiment, the E-CGI is mainly used for illustration, but when this embodiment is applied to a 5G NR system, the E-CGI may be replaced with the N-CGI, and the processing method is the same as that of this embodiment, which will not be repeated here.

It may be seen that by adopting the above implementations, the UE, determines, on the basis of the cell global identifier list configured at the network side, or on the basis of the configured PCI list and cell global identifier list, whether the cell belongs to the configured area; furthermore, according to the determined result, determines whether to continue to use the idle signal measurement configuration configured by the dedicated signaling. In this way, it solves a problem that the UE misjudges a cell with a same PCI but does not belong to a first area where it is located, so that the UE may more accurately determine whether a reselected cell belongs to a specific area, thereby avoiding unnecessary measurement behavior of the UE caused by the misjudging.

### Embodiment 3

An embodiment of the present disclosure provides a UE. As shown in FIG. 3, the UE includes:

a first processing unit 31, configured to: if within a first area while performing cell re-selection, determine, on the basis of a cell global identifier list configured at a network side, or on the basis of a PCI list and the cell global identifier list configured at the network side, whether a cell to be re-selected belongs to the first area; if so, continue to use an idle state measurement configuration configured by dedicated signaling to perform processing.

It should be noted that the embodiments of the present disclosure may be applied to various communication systems, such as: a Global System of Mobile Communication (GSM) system, a Code Division Multiple Access (CDMA) system, a Wideband Code Division Multiple Access (WCDMA) system, a General Packet Radio Service (GPRS), a Universal Mobile Telecommunication System (UMTS), an LTE system and LTE system evolution system (e.g., an Advanced Long Term Evolution (LTE-A) system), an NR system and NR system evolution system (e.g., an NR-based access to Unlicensed spectrum (NR-U)), or a next-generation communication system, etc.

A User Equipment (UE) may be a STAION (ST) in a Wireless Local Area Network (WLAN), and may be a cellular phone, a cordless phone, a Session Initiation Protocol (SIP) phone, a Wireless Local Loop (WLL) station, a Personal Digital Assistant (PDA) device, a handheld device with a wireless communication function, a computing device or other processing devices connected to a wireless modem, an vehicle-mounted device, a wearable device and a next-generation communication system, such as: a terminal device in a fifth-generation (5G) network or a terminal device in a Public Land Mobile Network (PLMN) that will evolve in the future, etc.

The above network side may be understood as a network apparatus in the network, which may be an apparatus for communicating with a mobile device, and the network apparatus may be an Access Point (AP) in a WLAN, a Base Transceiver Station (BTS) in GSM or CDMA, and may also be a NodeB (NB) in WCDMA, or an Evolutional Node B (eNB or eNodeB) in LTE, or a relay station or access point, or a vehicle-mounted device, a wearable device and a network apparatus in the NR network or a network apparatus in the PLMN that will evolve in the future.

In the embodiment of the present disclosure, the network apparatus may provide services for the cell, and the UE communicates with the network apparatus through transmission resources (e.g., frequency domain resources, or spectrum resources) used by the cell, and the cell may be a cell corresponding to a network apparatus (e.g., a base station), the cell may belong to a macro base station, or may belong to a base station corresponding to a small cell. The small cell may include: a Metro cell, a Micro cell, a Pico cell, a Femto cell, etc.

It should be noted that the network side may only send the PCI list to the UE side, but this process will not be described in detail in this embodiment.

The UE further includes: a first communication unit 32, configured to obtain the PCI and the cell global identification list configured at the network side through RRC signaling.

Specifically, the base station may send the PCI list+the cell global identifier list to the UE; further, the implementations provided by the embodiments of the present disclosure are also applicable to 5G NR systems. Both LTE and NR use the PCI as a physical layer cell identifier, and the cell global identifier may be an E-UTRA Cell Global Identifier (E-CGI) and an NR Cell Global Identifier (N-CGI), respectively. In the LTE system or 5G NR system, the E-CGI or N-CGI sent by the base station may be optional.

If the network side configures the cell global identifier list for the UE side, then, if the UE is within a first area while performing cell re-selection, on the basis of a cell global identifier list configured at a network side, or on the basis of a PCI list and the cell global identifier list configured at the network side, whether a cell to be re-selected belongs to the first area is determined, and the following processes may exist.

First:

The first processing unit 31, is configured to: if the UE is within the first area and a timer has not expired, if the UE performs the cell re-selection, determine whether a PCI of the cell is in the PCI list configured at the network side; if the PCI of the cell is not in the PCI list, determine that the cell does not belong to the first area.

That is, if the UE has not left the first area and the timer has not expired, then, when the UE determines whether a cell belongs to a configured active area during a re-selection process, if a value of the PCI is different from any value in the configured PCI list, determine that the cell must not belong to the first area.

Second: The first processing unit 31 is configured to: if the UE is within the first area and a timer has not expired, if the UE performs the cell re-selection, determine whether a PCI of the cell is in the PCI list configured at the network side, and determine whether a cell global identifier of the cell is the same as the cell global identifier configured at the network side;

if the PCI of the cell is in the PCI list configured at the network side, and the cell global identifier of the cell is the same as the cell global identifier configured at the network side, determine that the cell belongs to the first area.

It should be further explained that the method for the UE to obtain the global identifier of the cell may be read from a system message sent by the network side. More specifically, the cell global identifier may be read from SIB 1 in the system message sent by the network side; for example, E-CGI.

That is, if the UE has not left the first area and the timer has not expired, during the cell re-selection process, if the value of the PCI is the same as a PCI value in the configured PCI list, the UE needs to read SIB1 and obtain E-CGI to further compare whether the cell belongs to this first area;

if there is a same identifier in the E-CGI of the cell read by the UE and the E-CGI list configured at the network side, it is determined that the cell belongs to the first area.

Third: The first processing unit 31 is configured to: when performing the cell re-selection, if a reselected cell is not within the first area and/or the timer expires, determine that the UE leaves the first area.

That is, if the UE finds that a cell that does not belong to the first area is reselected or the timer expires, it considers that the UE has left the first area.

Further, if the base station is only configured with an E-CGI list (e.g., with an inactive state), the terminal needs to always read the E-CGI.

It should be understood that in an implementation provided in this embodiment, the first area may be an active area, but it is not only suitable for an active area of carrier aggregation idle state measurement, but also suitable for other areas, such as a RAN Area with an inactive state, a Tracking Area (TA), a Registration Area (RA), etc., which is no longer exhaustive here.

Regarding a process of adding a CGI, that is, the cell global identifier, to a cell list (Cell list r-15), the following methods may be adopted:

IdleModeMeasurementConfigDedicated-r15 ::= SEQUENCE {
idleMeasuredCarriersEUTRA-r15 EUTRA-CarrierList-r15

OPTIONAL, -- Need OR

| | |
|---|---|
| idleMeasurementDuration-r15 | ENUMERATED {sec10, sec30, sec60, |

sec120, sec180, sec240, sec300},

| | | |
|---|---|---|
| validity Area-r15 | CellList-r15 | OPTIONAL - |

- Need OR

| ... | |
|---|---|
| } | |
| CellList-r15 ::= | SEQUENCE (SIZE (1.. maxCellMeasIdle-r15)) OF |

validCellList

| validCellList:= SEQUENCE { | | |
|---|---|---|
| physicalCellID | PhysicalCellID, | |
| cellGlobalId | CellGlobalIdEUTRA, | OPTIONAL |

}

On the basis of the foregoing description, this embodiment may further include:

The first communication unit 32, is configured to: send information of a cell where PCI confusion occurs to the network side; wherein, the information of the cell where the PCI confusion occurs includes at least: a PCI and a cell global identifier of the cell; receive reconfiguration information for the cell where the PCI confusion occurs sent by the network side; wherein, the reconfiguration information includes a PCI of a reconfigured PCI of the cell where the PCI confusion occurs.

For a scenario where the PCI confusion occurs, please refer to FIG. 2, for example, an area of Macro cell 1 contains two Small cells with PCI=301; in an area of Macro cell 2, there are two Small cells with PCI=302. It may be considered that the above two Small cells with PCI=301 and 302 will have the PCI confusion.

If the terminal finds that misjudging of the active area may be caused by PCI detection alone due to the PCI confusion, the terminal reports the information of the cell where the PCI confusion to the network side, and triggers the network side to reconfigure a PCI of a cell. When reporting, the terminal reports the PCI+E-CGI of the cell to the network together to assist the network in locating which cell has the PCI confusion.

In addition, the first processing unit 31 is configured to: if determining that the UE has left the first area, not use the idle state measurement configuration configured by the dedicated signaling of the first area.

It should be understood that, in this embodiment, the E-CGI is mainly used for illustration, but when this embodiment is applied to a 5G NR system, the E-CGI may be replaced with the N-CGI, and the processing method is the same as that of this embodiment, which will not be repeated here.

It may be seen that by adopting the above implementations, the UE, determines, on the basis of the cell global identifier list configured at the network side, or on the basis of the configured PCI list and cell global identifier list, whether the cell belongs to the configured area; furthermore, according to the determined result, determines whether to continue to use the idle signal measurement configuration configured by the dedicated signaling. In this way, it solves a problem that the UE misjudges a cell with a same PCI but does not belong to a first area where it is located, so that the UE may more accurately determine whether a reselected cell belongs to a specific area, thereby avoiding unnecessary measurement behavior of the UE caused by the misjudging.

### Embodiment 4

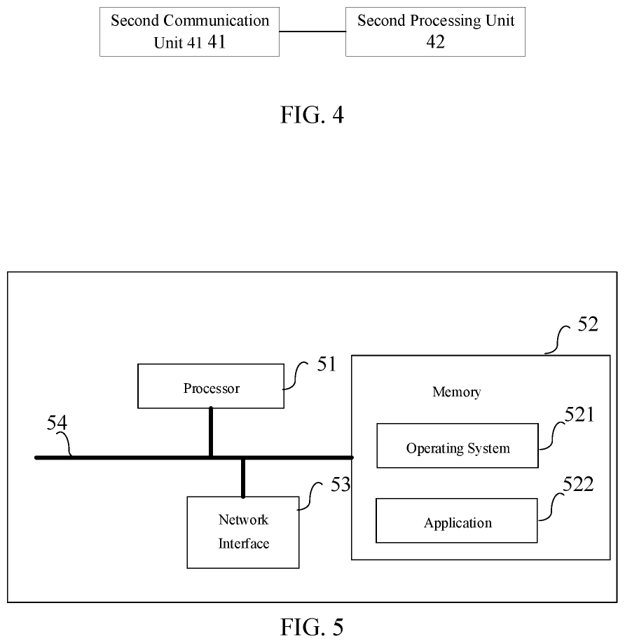

An embodiment of the present disclosure provides a network apparatus, as shown in FIG. 4, including:

a second communication unit 41, configured to: configure a UE with a cell global identifier list, or with a PCI list and the cell global identifier list.

The second communication unit 41 is specifically configure to: configure the UE with the cell global identifier list, or with the PCI list and the cell global identifier list through RRC signaling.

It should be noted that the embodiments of the present disclosure may be applied to various communication systems, such as: a Global System of Mobile Communication (GSM) system, a Code Division Multiple Access (CDMA) system, a Wideband Code Division Multiple Access (WCDMA) system, General Packet Radio Service (GPRS), a Universal Mobile Telecommunication System (UMTS), an LTE system and LTE system evolution system (e.g., an Advanced long term evolution (LTE-A) system), an NR system and NR system evolution system (e.g., an NR-based access to Unlicensed spectrum (NR-U) system), or a next-generation communication system, etc.

A User Equipment (UE) may be a STAION (ST) in a Wireless Local Area Network (WLAN), and may be a cellular phone, a cordless phone, a Session Initiation Protocol (SIP) phone, a Wireless Local Loop (WLL) station, a Personal Digital Assistant (PDA) device, a handheld device with a wireless communication function, a computing device or other processing device connected to a wireless modem, an vehicle-mounted device, a wearable device and the next-generation communication system, such as, a terminal device in a fifth-generation (5G) network or a terminal device in a Public Land Mobile Network (PLMN) that will evolve in the future.

The above network side may be understood as a network apparatus in the network, which may be an apparatus for communicating with a mobile device, and the network apparatus may be an Access Point (AP) in a WLAN, a Base Transceiver Station (BTS) in GSM or CDMA, and may also be a NodeB (NB) in WCDMA, or an Evolutional Node B (eNB or eNodeB) in LTE, or a relay station or access point, or a vehicle-mounted device, a wearable device and a network apparatus in the NR network or a network apparatus in the PLMN that will evolve in the future.

In the embodiment of the present disclosure, the network apparatus may provide services for the cell, and the UE communicates with the network apparatus through transmission resources (e.g., frequency domain resources, or spectrum resources) used by the cell, and the cell may be a cell corresponding to a network apparatus (e.g., a base station), the cell may belong to a macro base station, or may belong to a base station corresponding to a small cell. The small cell may include: a Metro cell, a Micro cell, a Pico cell, a Femto cell, etc.

It should be noted that the network side may only send a PCI list to a UE side, but this process will not be described in detail in this embodiment.

Specifically, the base station may send the PCI list+the cell global identifier list to the UE; further, the implementations provided by the embodiments of the present disclosure are also applicable to 5G NR systems. Both LTE and NR use the PCI as a physical layer cell identifier, and the cell global identifier may be an E-UTRA Cell Global Identifier (E-CGI) and an NR Cell Global Identifier (N-CGI), respectively. In the LTE system or 5G NR system, the E-CGI or N-CGI sent by the base station may be optional.

It should be understood that in an implementation provided in this embodiment, the first area may be an active area, but it is not only suitable for an active area of carrier aggregation idle state measurement, but also suitable for other areas, such as a RAN Area with an inactive state, a Tracking Area (TA), a Registration Area (RA), etc., which is no longer exhaustive here.

Regarding a process of adding a CGI, that is, the cell global identifier, to a cell list (Cell list r-15), the following methods may be adopted:

IdleModeMeasurementConfigDedicated-r15 ::= SEQUENCE {
idleMeasuredCarriersEUTRA-r15 EUTRA-CarrierList-r15

OPTIONAL, -- Need OR

| | |
|---|---|
| idleMeasurementDuration-r15 | ENUMERATED {sec10, sec30, sec60, |

sec120, sec180, sec240, sec300},

| | | |
|---|---|---|
| validity Area-r15 | CellList-r15 | OPTIONAL - |

- Need OR

| ... | |
|---|---|
| } | |
| CellList-r15 ::= | SEQUENCE (SIZE (1.. maxCellMeasIdle-r15)) OF |

validCellList

| validCellList:= SEQUENCE { | | |
|---|---|---|
| physicalCellID | PhysicalCellID, | |
| cellGlobalId | CellGlobalIdEUTRA, | OPTIONAL |

}

On the basis of the foregoing description, this embodiment may further include:

The second communication unit 41, is configured to: receive, from the UE, information of a cell where PCI confusion occurs, wherein, the information of the cell where the PCI confusion occurs includes at least: a PCI and a cell global identifier of the cell;

send reconfiguration information for the cell where the PCI confusion occurs to the UE; wherein, the reconfiguration information includes at least: a PCI and a cell global identifier of a reconfigured PCI of the cell where the PCI confusion occurs.

For a scenario where the PCI confusion occurs, please refer to FIG. 2, for example, an area of Macro cell 1 contains two Small cells with PCI=301; in an area of Macro cell 2, there are two Small cells with PCI=302. It may be considered that the above two Small cells with PCI=301 and 302 will have the PCI confusion.

If the terminal finds that misjudging of the active area may be caused by PCI detection alone due to the PCI confusion, the terminal reports the information of the cell where the PCI confusion to the network side, and triggers the network side to reconfigure a PCI of a cell. When reporting, the terminal reports the PCI+E-CGI of the cell to the network together to assist the network in locating which cell has the PCI confusion.

The network apparatus further includes:

a second processing unit 42, configured to: if the PCI confusion is occurred in the first area where the UE is located, configuring the UE with the cell global identifier list, or with the PCI list and the cell global identifier list;

or,

the second processing unit 42, is configured to: if no PCI confusion is occurred in the first area where the UE is located, only configuring the UE with the PCI list.

A basis for the network to determine whether an E-CGI is configured in the active area may be whether there is the PCI confusion in an area configured for the UE, if yes, the E-CGI is configured, and if not, no configuration is required. Compared with simply configuring the E-CGI, using PCI+E-CGI, may firstly determine if it has left the current area by whether the PCI is same, while it is unnecessary to read system information. Of course, this benefit may only be more obvious when the area is not large. In addition, the method of determining whether the UE has the PCI confusion within the first area may report the PCI confusion for the UE, for example, reporting PCI confusion information sent in a cell within the first area, and so on.

It should be understood that, in this embodiment, the E-CGI is mainly used for illustration, but when this embodiment is applied to a 5G NR system, the E-CGI may be replaced with the N-CGI, and the processing method is the same as that of this embodiment, which will not be repeated here.

It may be seen that by adopting the above implementations, the UE, determines, on the basis of the cell global identifier list configured at the network side, or on the basis of the configured PCI list and cell global identifier list, whether the cell belongs to the configured area; furthermore, according to the determined result, determines whether to continue to use the idle signal measurement configuration configured by the dedicated signaling. In this way, it solves a problem that the UE misjudges a cell with a same PCI but does not belong to a first area where it is located, so that the UE may more accurately determine whether a reselected cell belongs to a specific area, thereby avoiding unnecessary measurement behavior of the UE caused by the misjudging.

An embodiment of the present disclosure further provides a hardware composition architecture of a UE or network apparatus, as shown in FIG. 5, including: at least one processor 51, a memory 52, and at least one network interface 53. The various components are coupled together via a bus system 54. Understandably, the bus system 54 is used to implement connection and communication between these components. In addition to a data bus, the bus system 54 further includes a power bus, a control bus, and a status signal bus. However, for the sake of clarity, various buses are marked as the bus system 54 in FIG. 5.

It may be understood that the memory 52 in the embodiment of the present disclosure may be a volatile memory or a non-volatile memory, or may include both volatile and non-volatile memory.

In some embodiments, the memory 52 stores the following elements, executable modules or data structures, or their subsets, or their extensions:

an operating system 521 and an application 522.

The processor 51 is configured to be able to process the method steps of Embodiment 1 or 2, which will not be repeated here.

If the above apparatus in the embodiment of the present disclosure is implemented in the form of a software function module and sold or used as an independent product, it may also be stored in a computer-readable storage medium. Based on this understanding, the implementations of the embodiments of the present disclosure may be embodied in the form of software products in essence or part of contributions to the existing technology. The computer software product is stored in a storage medium and includes several instructions for a computer device (which may be a personal computer, server, or network apparatus, etc.) executes all or part of the methods described in the embodiments of the present disclosure. The foregoing storage media include various media that may store program codes, such as a U disk, a mobile hard disk, a Read Only Memory (ROM), a magnetic disk, or an optical disk. In this way, the embodiments of the present disclosure are not limited to any specific combination of hardware and software.

An embodiment of the present disclosure provides a computer storage medium that stores computer-executable instructions. When the computer-executable instructions are executed, the method steps of the foregoing Embodiment 1 or 2 are implemented.

Although the preferred embodiments of the present disclosure have been disclosed for illustrative purposes, those skilled in the art will realize that various improvements, additions, and substitutions are also possible, and therefore, the scope of the present disclosure should not be limited to the above-described embodiments.

What is claimed is:

1. A measurement control method, applied to a UE, wherein, the method comprises:
if the UE is within a first area while performing cell re-selection, determining, on the basis of a cell global identifier list configured at a network side, or on the basis of a PCI list and the cell global identifier list configured at the network side, whether a cell to be re-selected belongs to the first area; and
if it is determined that the cell to be re-selected belongs to the first area, continuing to use an idle state measurement configuration configured by dedicated signaling to perform processing.

2. The method according to claim 1, wherein, if the UE is within the first area while performing cell re-selection, determining, on the basis of the cell global identifier list configured at the network side, or on the basis of the PCI list and the cell global identifier list configured at the network side, whether the cell to be re-selected belongs to the first area, comprises:
if the UE is within the first area and a timer has not expired, determining whether a PCI of the cell is in the PCI list configured at the network side while performing the cell re-selection; and
if the PCI of the cell is not in the PCI list, determining that the cell does not belong to the first area.

3. The method according to claim 1, wherein, if the UE is within the first area while performing cell re-selection, determining, on the basis of the cell global identifier list configured at the network side, or on the basis of the PCI list and the cell global identifier list configured at the network side, whether the cell to be re-selected belongs to the first area, comprises:
if the UE is within the first area and a timer has not expired, determining whether a PCI of the cell is in the PCI list configured at the network side, and determining whether a cell global identifier of the cell is same as the cell global identifier configured at the network side while performing the cell re-selection; and
if the PCI of the cell is in the PCI list configured at the network side, and the cell global identifier of the cell is the same as the cell global identifier configured at the network side, determining that the cell belongs to the first area.

4. The method according to claim 1, wherein, the method further comprises:
when performing the cell re-selection, if a reselected cell is not within the first area and/or a timer expires, determining that the UE leaves the first area.

5. The method according to claim 1, wherein, the method further comprises:
sending to the network side information of a cell where PCI confusion occurs;
wherein, the information of the cell where the PCI confusion occurs comprises at least: a PCI and a cell global identifier of the cell.

6. The method according to claim 5, wherein, the method further comprises:
receiving reconfiguration information for the cell where the PCI confusion occurs sent by the network side;
wherein, the reconfiguration information comprises a reconfigured PCI of the cell where the PCI confusion occurs.

7. The method according to claim 1, wherein, the method further comprises:
obtaining the cell global identifier list, or the PCI list and the cell global identifier list configured at the network side through RRC signaling.

8. The method according to claim 1, wherein, the first area is one of the following:
an active area and an inactive area.

9. A measurement control method, applied to a network apparatus, wherein, the method comprises:
configuring a UE with a cell global identifier list, or with a PCI list and the cell global identifier list.

10. The method according to claim 9, wherein, configuring the UE with the cell global identifier list, or with the PCI list and the cell global identifier list, further comprises:
if a PCI confusion is occurred in a first area where the UE is located, configuring the UE with the cell global identifier list, or with the PCI list and the cell global identifier list.

11. The method according to claim 9, wherein, the method further comprises:
receiving, from the UE, information of a cell where PCI confusion occurs, wherein, the information of the cell where the PCI confusion occurs comprises at least: a PCI and a cell global identifier of the cell;
sending, to the UE, reconfiguration information for the cell where the PCI confusion occurs; wherein, the reconfiguration information comprises at least: a reconfigured PCI of the cell where the PCI confusion occurs.

12. The method according to claim 9, wherein, the method further comprises:
configuring the UE with the cell global identifier list, or with the PCI list and the cell global identifier list through RRC signaling.

13. A UE, comprising: a processor and a memory for storing a computer program that is executable on the processor,
wherein, when the processor is used to execute the computer program, the execution causes the processor to:
if within a first area while performing cell re-selection, determine, on the basis of a cell global identifier list configured at a network side, or on the basis of a PCI list and the cell global identifier list configured at the network side, whether a cell to be re-selected belongs to the first area; and if it is determined that the cell to be re-selected belongs to the first area, continue to use an idle state measurement configuration configured by dedicated signaling to perform processing.

14. The UE according to claim 13, wherein, the processor is further caused to: if within the first area and a timer has not expired, determine whether a PCI of the cell is in the PCI list configured at the network side while performing the cell re-selection; and if the PCI of the cell is not in the PCI list, determine that the cell does not belong to the first area.

15. The UE according to claim 13, wherein, the processor is further caused to: if within the first area and a timer has not expired, determine whether a PCI of the cell is in the PCI list configured at the network side, and determine whether a cell global identifier of the cell is same as the cell global identifier configured at the network side while performing the cell re-selection; and
if the PCI of the cell is in the PCI list configured at the network side, and the cell global identifier of the cell is the same as the cell global identifier configured at the network side, determine that the cell belongs to the first area.

16. The UE according to claim 13, wherein, the processor is further caused to: when performing the cell re-selection, if a reselected cell is not within the first area and/or a timer expires, determine to leave the first area.

17. The UE according to claim 13, wherein, the UE further comprises a network interface, and the execution causes the network interface to:
send to the network side information of a cell where PCI confusion occurs;
wherein, the information of the cell where the PCI confusion occurs comprises at least: a PCI and a cell global identifier of the cell;

18. The UE according to claim 17, wherein, the network interface is further caused to receive reconfiguration information for the cell where the PCI confusion occurs sent by the network side; wherein, the reconfiguration information comprises a reconfigured PCI of the cell where the PCI confusion occurs.

19. The UE according to claim 13, wherein, the network interface is further caused to obtain the PCI and the cell global identification list configured at the network side through RRC signaling.

20. The UE according to claim 13, wherein, the first area is one of the following:
an active area and an inactive area.
